(19) United States
(12) Patent Application Publication
(10) Pub. No.: US 2020/0260082 A1
(43) Pub. Date: Aug. 13, 2020

(54) METHOD AND DEVICE FOR ENCODING OR DECODING 360 VIDEO

(71) Applicant: SK TELECOM CO., LTD., Seoul (KR)

(72) Inventors: Jeong-yeon LIM, Seoul (KR); Hyo Song KIM, Seoul (KR); Se-hoon SON, Seoul (KR); Jae-seob SHIN, Seoul (KR); Gyeong-taek LEE, Seoul (KR); Sun-young LEE, Seoul (KR)

(21) Appl. No.: 16/635,815

(22) PCT Filed: Jul. 30, 2018
(86) PCT No.: PCT/KR2018/008607

§ 371 Date: Jan. 31, 2020

(30) Foreign Application Priority Data
Jul. 31, 2017 (KR) 10-2017-0097273
Sep. 5, 2017 (KR) 10-2017-0113525

(51) Int. Cl. H04N 19/124; H04N 13/194; H04N 19/61

(52) U.S. Cl. CPC H04N 19/124; H04N 19/61; H04N 13/194

(57) ABSTRACT

The present disclosure relates to image encoding or decoding for efficiently encoding 360-degree video and mitigating image quality deterioration due to discontinuity artifacts.

### TECHNICAL FIELD

The present disclosure in some embodiments relates to image encoding or decoding for efficiently encoding 360-degree video images and mitigating image degradation.

### BACKGROUND

The statements in this section merely provide background information related to the present disclosure and do not necessarily constitute prior art.

360-degree video (hereinafter referred to as ‘360-video’) is video data taken from multiple directions by multiple cameras or an omni-directional camera. Such a 360-video is obtained by stitching variously directed videos in a compressible and transmittable form of single 2-dimensional (2D) video. The stitched video is then compressed and transmitted to a decoding apparatus. The decoding apparatus processes the compressed video after the decoding so that it is mapped to and played back in its 3D equivalent.

The typical projection format for 360-video is Equirectangular Projection (ERP). The ERP format has the disadvantage of overly distorting the 3D spherical 360-video by excessively increasing the pixels of the top and bottom portions thereof, and also increasing the amount of data and the encoding throughput in the over pixelated portions at the time of compressing the video. So proposals have been made for various projection formats that can replace the ERP format.

For example, proposed are projection formats including Cubemap Projection (CMP), Octahedron Projection (OHP), Icosahedron Projection (ISP), Segmented Sphere Projection (SSP), Rotated Sphere Projection (RSP), and Truncated Square Pyramid Projection (TSP). Additional projection formats in discussion are Adjusted Cubemap Projection (ACP) and Equiangular Cubemap (EAC) which are complementary to CMP along with Equal Area Projection (EAP) and Adjusted Equal Area Projection (AEP) which are complementary to the typical ERP.

In spite of various projection formats being proposed to reduce the distortion of 360-video and increase the compression efficiency, the layout of the 2D projection image according to those respective projection formats is bound to present portions with such faces becoming adjacent to each other that are not contiguous to each other in the 3D space in the first place. Upon encoding and decoding such regions with discontinuity, i.e., discontinuity edges, the subsequent rendering and play back of the same by stitching the regions with discontinuity together will cause discontinuity artifacts to occur, resulting in deteriorated image quality.

### DISCLOSURE

### Technical Problem

The present disclosure in some embodiments seeks to provide 360-video encoding and decoding technique that can alleviate discontinuity artifacts to improve the image quality of the 360-video.

### SUMMARY

At least one aspect of the present disclosure provides a method of encoding a 360-degree video, including generating a 2-dimensional (2D) image by projecting the 360-video based on any one of the one or more projection formats, encoding the 2D image that is padded or unpadded according to whether or not the 2D image is padded according to any one underlying projection format out of the projection formats, and encoding a syntax element for padding information of the 2D image.

Another aspect of the present disclosure provides a method of decoding a 360-degree video, including decoding, from a bitstream, a syntax element for a projection format of the 360-degree video and a syntax element for padding information of a 2D image generated by projecting the 360-video 2-dimensionally based on the projection format, and decoding the 2D image from the bitstream, and when the syntax element for the padding information of the 2D image indicates that the 2D image is padded, removing a padding region from a decoded 2D image by using at least one of the syntax element for the projection format and the syntax element for the padding information of the 2D image, and then outputting the 2D image with the padding region removed to a renderer, and when the syntax element for the padding information of the 2D image indicates that the 2D image is not padded, outputting the decoded 2D image straight to the renderer.

Yet another aspect of the present disclosure provides an apparatus for decoding a 360-degree video including a decoding unit and a 2D image output unit. The decoding unit is configured to decode, from a bitstream, a syntax element for a projection format of the 360-video and a syntax element for padding information of a 2D image generated by projecting the 360-degree video 2-dimensionally based on the projection format, and to decode the 2D image from the bitstream. The 2D image output unit is configured to remove a padding region from a decoded 2D image by using at least one of the syntax element for the projection format and the syntax element for the padding information of the 2D image when the syntax element for the padding information of the 2D image indicates that the 2D image is padded, and then to output the 2D image with the padding region removed to a renderer, but to output the decoded 2D image to the renderer when the syntax element for the padding information of the 2D image indicates that the 2D image is not padded.

### [BRIEF DESCRIPTION OF THE DRAWINGS]

FIG. 1 is a block diagram of at least one embodiment of an encoding apparatus to which the present disclosure is applied.

FIG. 2 is a block diagram of at least one embodiment of a decoding apparatus to which the present disclosure is applied.

FIG. 3 is a flowchart of a method of encoding a 360-video according to at least one embodiment of the present disclosure.

FIG. 4 shows diagrams of example padding regions for the ERP family projection format.

FIG. 5 is a diagram of example padding for the ERP family projection format.

FIG. 6 shows diagrams of example padding regions for the CMP family projection format.

FIG. 7 shows conceptual diagrams for describing a method of obtaining a pixel value used for padding.

FIG. 8 shows diagrams of example padding regions of the ECP projection format.

FIG. 9 is a diagram of example padding regions of the SSP projection format.

FIG. 10 is a diagram of example padding regions of the RSP projection format.

FIG. 11 is a diagram of example padding regions of the OHP projection format.

FIG. 12 shows an example reference picture type according to the ERP projection format.

FIG. 13 shows an example reference picture type according to the CMP projection format.

FIG. 14 shows an example reference picture type according to the CMP projection format.

FIG. 15 is a flowchart of a method of decoding a 360-video according to at least one embodiment of the present disclosure.

FIG. 16 is a schematic block diagram of an apparatus for encoding a 360-video according to at least one embodiment of the present disclosure.

FIG. 17 is a schematic block diagram of an apparatus for decoding a 360-video according to at least one embodiment of the present disclosure.

### [DETAILED DESCRIPTION]

Hereinafter, some embodiments of the present disclosure will be described in detail with reference to the accompanying drawings. In the following description, like reference numerals designate like elements, although the elements are shown in different drawings. Further, in the following description of some embodiments, a detailed description of known functions and configurations incorporated therein will be omitted for the purpose of clarity and for brevity.

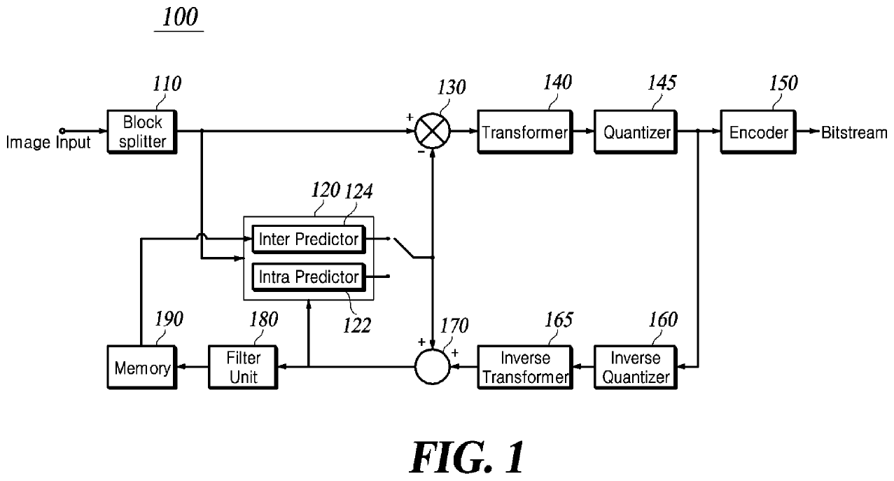

FIG. 1 is a block diagram of at least one embodiment of an encoding apparatus 100 to which the present disclosure is applied.

The encoding apparatus 100 includes a block splitter 110, a predictor 120, a subtractor 130, a transformer 140, a quantizer 145, an encoder 150, an inverse quantizer 160, and an inverse transformer 165, an adder 170, a filter unit 180, and a memory 190. Each component of the encoding apparatus 100 may be implemented by a hardware chip, or may be implemented by software and a microprocessor for executing a function of software corresponding to each component.

The block splitter no divides each picture constituting video images into a plurality of Coding Tree Units (CTUs), and it then recursively divides the CTUs by using a tree structure. A leaf node in the tree structure becomes a coding unit (CU) which is a basic unit of coding. Those used as a tree structure may be QuadTree (QT) in which the parent node splits into four child nodes, or a QTBT (QuadTree plus BinaryTree) structure from using the QT structure mixed with a BinaryTree (BT) structure in which the parent node splits into two child nodes.

The predictor 120 generates a predicted block by predicting the current block. The predictor 120 includes an intra predictor 122 and an inter predictor 124. Here, a current block is a basic unit of encoding corresponding to a leaf node in the tree structure, and means a CU to be currently encoded. Alternatively, the current block may be one subblock of the plurality of subblocks divided from the CU.

The intra predictor 122 predicts pixels in the current block included in the current picture by using peripheral pixels (reference pixels) positioned around the current block. There are a plurality of intra prediction modes according to the prediction direction, and different reference pixel and different operation formula to be used are defined according to each prediction mode. The plurality of intra prediction modes may include two non-directional modes (planar mode and DC mode) and 65 directional modes. The intra predictor 122 selects one intra prediction mode from among the plurality of intra prediction modes and predicts the current block by using the peripheral pixels or reference pixels and an operation formula determined according to the selected intra prediction mode. Information about the selected intra prediction mode is encoded by the encoder 150 and transmitted to a decoding apparatus.

The inter predictor 124 searches for the block most similar to the current block in a reference picture which is coded and decoded before the current picture and generates a predicted block of the current block by using the searched block. The inter predictor 124 also generates a motion vector (MV) corresponding to a displacement between the current block in the current picture and the predicted block in the reference picture. Motion information, which includes the information on the reference picture used to predict the current block and information on the motion vector, is encoded by the encoder 150 and transmitted to the decoding apparatus.

The subtractor 130 subtracts the predicted block generated by the intra predictor 122 or the inter predictor 124 from the current block to generate a residual block.

The transformer 140 transforms a residual signal in the residual block having pixel values of a spatial domain into a transform coefficient of the frequency domain. The transformer 140 may transform residual signals in the residual block by using the size of the current block as a transform unit, or it may divide the residual block into a plurality of smaller subblocks and transform the residual signals in a subblock-sized transform unit. There may be various ways of dividing the residual block into smaller subblocks. For example, it may be divided into subblocks having the same size defined in advance, or may use a quadtree (QT) method using a residual block as a root node.

The quantizer 145 quantizes the transform coefficients outputted from the transformer 140 and outputs the quantized transform coefficients to the encoder 150.

The encoder 150 generates a bitstream by encoding the quantized transform coefficients by using such an encoding method as CABAC. In addition, the encoder 150 encodes information about the size of the CTU (Coding Tree Unit) located in the highest layer of the tree structure and division or split information from the CTU, which is for dividing the block into the tree structure, so that the decoding apparatus divides the block in the same way as the encoding apparatus. For example, with QT (QuadTree) splitting, the encoder 150 encodes QT split information indicating whether a block of an upper layer is divided into four blocks of a lower layer. With BT (BinaryTree) splitting, the encoder 150 encodes BT split information indicating whether each block is divided into two blocks and the type of their split, starting from the block corresponding to the leaf node of the QT.

The encoder 150 encodes information on a prediction type indicating whether the current block is encoded by intra prediction or inter prediction, and it encodes intra prediction information or inter prediction information according to the prediction type.

The inverse quantizer 160 inversely quantizes the quantized transform coefficients outputted from the quantizer 145 to generate transform coefficients. The inverse transformer 165 reconstructs the residual block by transforming the transform coefficients outputted from the inverse quantizer 160 from the frequency domain to the spatial domain.

The adder 170 reconstructs the current block by adding the reconstructed residual block and the predicted block generated by the predictor 120. The pixels in the reconstructed current block are used as reference pixels when performing intra prediction in the next order of block.

The filter unit 180 deblock-filters the boundaries between the reconstructed blocks in order to remove blocking artifacts that occur due to blockwise encoding/decoding, and it stores the deblock filtered blocks in the memory 190. When all blocks in one picture are reconstructed, the reconstructed picture is used as a reference picture for inter prediction of a block in a picture, which is to be subsequently encoded. The memory 190 may also be referred to as a reference picture buffer.

The image encoding technique described above is also applicable to when projecting the 360-video in 2D and then encoding a 2D image.

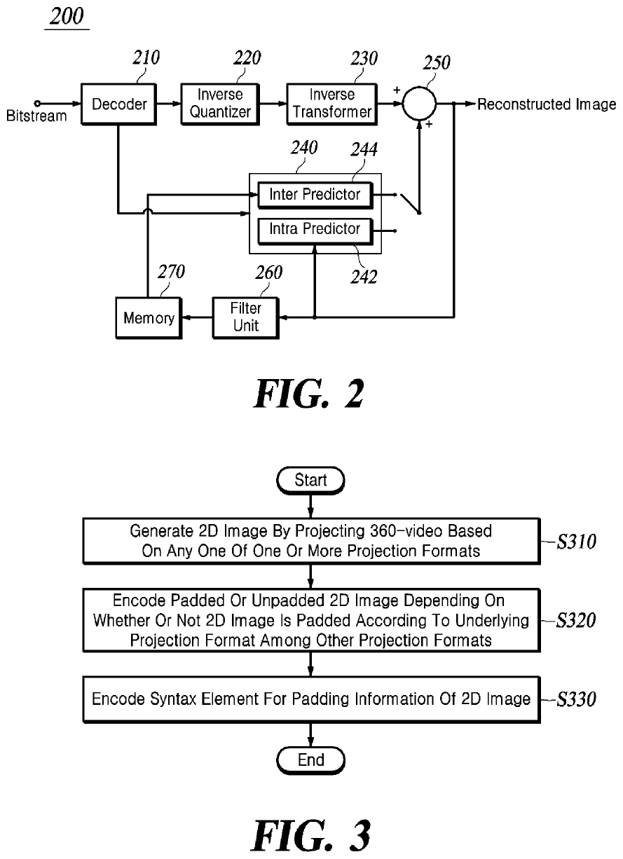

FIG. 2 is a block diagram of at least one embodiment of a decoding apparatus 200 to which the present disclosure is applied.

The decoding apparatus 200 includes a decoder 210, an inverse quantizer 220, an inverse transformer 230, a predictor 240, an adder 250, a filter unit 260, and a memory 270. The components shown in FIG. 2 may be implemented by a hardware chip, or may be implemented by software and a microprocessor for executing functions of software corresponding to the respective components.

The decoder 210 decodes the bitstream received from the encoding apparatus 100 to extract information related to block division to determine a current block to be decoded, and to extract prediction information and information on residual signal necessary for reconstructing the current block.

The decoder 210 extracts information on the CTU size from a Sequence Parameter Set (SPS) or Picture Parameter Set (PPS) to determine the size of the CTU, and divides the picture into CTUs of the determined size. The decoder 210 determines the CTU as the highest layer of the tree structure, that is, the root node and extracts split information of the CTU and thereby splits the CTU by using the tree structure. For example, when splitting a CTU by using a QTBT structure, initially, a first flag (QT split flag) related to the splitting of the QT is extracted, and each node is divided into four nodes of a lower layer. For the node corresponding to the leaf node of the QT, the second flag BT_split_flag and the split type information related to the splitting of the BT are extracted to split that leaf node in the BT structure.

The decoder 210, upon determining the current block to be decoded by splitting in the tree structure, extracts information about a prediction type indicating whether the current block was intra predicted or inter predicted. When the prediction type information indicates intra prediction, the decoder 210 extracts a syntax element for intra prediction information (e.g., intra prediction mode, information on a reference pixel, etc.) of the current block. When the prediction type information indicates inter prediction, the decoder 210 extracts a syntax element for inter prediction information (e.g., inter prediction mode).

Meanwhile, the decoder 210 extracts information on quantized transform coefficients of the current block as information on the residual signal.

The inverse quantizer 220 inversely quantizes the quantized transform coefficients, and the inverse transformer 230 inversely transforms the inverse quantized transform coefficients from the frequency domain to the spatial domain to generate a residual block for the current block.

The prediction unit 240 includes an intra predictor 242 and an inter predictor 244. The intra predictor 242 is activated when the intra prediction is the prediction type of the current block, and the inter predictor 244 is activated when the inter prediction is the prediction type of the current block.

The intra predictor 242 determines the intra prediction mode of the current block among the plurality of intra prediction modes from a syntax element for the extracted intra prediction mode from the decoder 210, and it predicts the current block by using reference pixels around the current block according to the intra prediction mode. In addition, the intra predictor 242 may set among others a value of a reference pixel to be used for intra prediction from a syntax element for the extracted reference pixel from the decoder 210.

The inter predictor 244 determines motion information of the current block by using a syntax element of the extracted inter prediction mode from the decoder 210 and predicts the current block by using the determined motion information.

The adder 250 reconstructs the current block by adding the residual block outputted from the inverse transformer 230 and the predicted block outputted from the inter predictor 244 or the intra prediction unit 242. The pixels in the reconstructed current block are utilized as reference pixels in intra prediction of a block to be subsequently decoded.

The filter unit 260 deblock-filters the boundaries between the reconstructed blocks in order to remove blocking artifacts that occur due to block-by-block decoding, and it stores the deblock-filtered blocks in the memory 270. When all blocks in one picture are reconstructed, the reconstructed picture is used as a reference picture for inter prediction of a block in a picture, which is to be subsequently decoded. The memory 270 may also be referred to as a reference picture buffer.

The image decoding technique described above is also applicable to when decoding a 2D image projected from a 360-video and encoded.

The 2D projection image layout in various projection formats including ERP, a representative projection format used for 360-video is bound to present portions with such faces becoming adjacent to each other that are not contiguous to each other in the 3D space in the first place. On the contrary, there are portions bound to be present on the 2D image layout with such faces becoming non-adjacent to each other that are contiguous to each other in the 3D space in the first place. Upon encoding and decoding such regions with discontinuity, i.e., discontinuity edges, the subsequent rendering and play back of the same by stitching the regions with discontinuity together will cause discontinuity artifacts to occur, resulting in deteriorated image quality. Accordingly, the present disclosure in some embodiments aims to provide a 360-video encoding method and apparatus that can improve image quality deterioration due to discontinuity by padding 2D images according to layouts of various projection formats. In addition, after encoding and decoding padded 2D images, the present disclosure works for increasing compression performance by using the reconstructed 2D image as a reference picture for inter-screen prediction.

FIG. 3 is a flowchart of a method of encoding 360-video according to at least one embodiment of the present disclosure. The method of FIG. 3 may be performed by an encoding apparatus.

Referring to FIG. 3, the encoding apparatus generates a 2D image by projecting a 360-video based on any one of the one or more projection formats (S310). Examples of projection formats include Equirectangular Projection (ERP), Equal Area Projection (EAP), Adjusted Equal Area Projection (AEP), Cubemap Projection (CMP), Adjusted Cubemap Projection (ACP), Equal Area Projection (EAC), Equatorial Cylindrical Projection (ECP), Segmented Sphere Projection (SSP), Rotated Sphere Projection (RSP), Icosahedron Projection (ISP), and Octahedron Projection (OHP) among others. Hereinafter, ERP, EAP and AEP are ERP family. CMP, ACP and EAC are referred to as CMP family. Here, the projection format for projecting the 360-video may be selected from a plurality of projection formats by the encoding apparatus, or may be preset to a specific projection format.

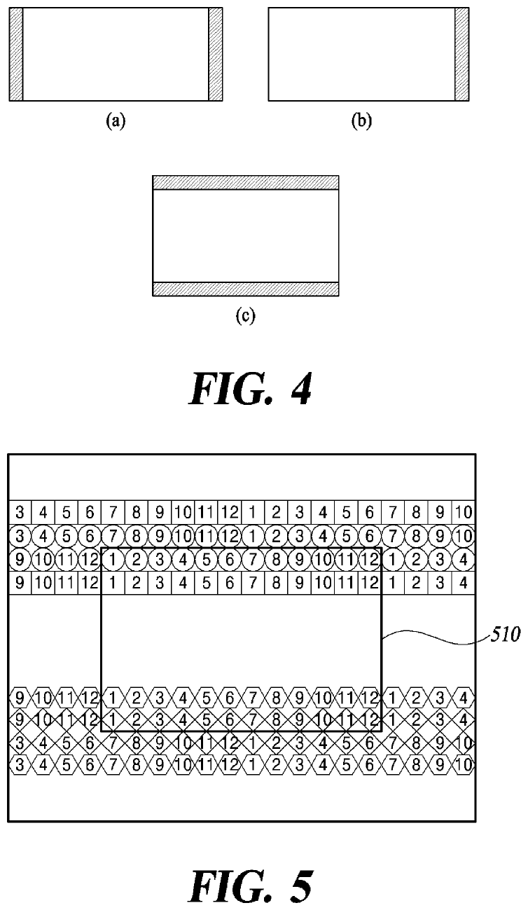

The encoding apparatus encodes the padded or unpadded 2D image depending on whether or not the 2D image is padded according to the underlying projection format among other projection formats (S320). The encoding apparatus may directly encode the 2D image on which the 360-video is projected. Alternatively, after padding the 2D image, the encoding apparatus may encode the padded 2D image. The method of padding the 2D image may vary depending on the projection format, and specific examples thereof will be described later with reference to FIGS. 4 to 11.

The encoding apparatus encodes a syntax element for the padding information of the 2D image (S330). Here, the padding information of the 2D image may include information indicating whether the 2D image is padded, and it may further include at least one of information indicating the width of the padding region, information indicating the position of the padding region with respect to the 2D image, and information indicating a configuration form of the padding region.

The syntax elements for the padding information of the 2D image according to some embodiments of the present disclosure are shown in Tables 1 to 3.

TABLE 1

Descriptor

360_video ( ) {
projection_format_idx
image_padding_pattern_flag
}

TABLE 2

Descriptor

360_video ( ) {
projection_format_idx
image_padding_pattern_flag
If (image_padding_pattern_flag > 0)
padded_width
}

TABLE 3

Descriptor

360 video ( ) {
projection_format_idx
image_padding_pattern_flag
If (image_padding_pattern_flag > 0)
padded_width
If (projection_format_idx == ERP)
padded_region
If (projection_format_idx == CMP or ECP)
padded_type_idx
}

projection_format_idx is a syntax element for the projection format of a 360-video. For example, the value of projection_format_idx may be configured as shown in Table 4. The index values and projection formats described in Table 4 are merely examples, which may have additional or some replacement projection formats that are not described, and different index values may be configured for the respective projection formats.

TABLE 4

| Index | Projection format | Description |
|---|---|---|
| 0 | ERP | Equirectangular projection |
| 1 | CMP | Cubemap projection |
| 2 | ISP | Icosahedron projection |
| 3 | OHP | Octahedron projection |
| 4 | EAP | Equal-area projection |
| 5 | TSP | Truncated square pyramid projection |
| 6 | SSP | Segmented sphere projection |

image_padding_pattern_flag is a syntax element for the information indicating whether the 2D image is padded. For example, the value of image_padding_pattern_flag may be configured as shown in Table 5.

TABLE 5

| Index | Description |
|---|---|
| 0 | not padded |
| 1 | padded |

According to the example of Table 5, when the 2D image is not padded, the encoding apparatus encodes image_padding_pattern_flag with a value of “0,” and when the 2D image is padded, it encodes the image_padding_pattern_flag with a value of “1”. padded_width is a syntax element for the information indicating the width of the padding region. The width of the padding region may be represented by the number of pixels. For example, when the value of padded_width is “4,” the width of the padding region in the 2D image is 4 pixels.

padded_region is a syntax element for the information indicating the position of a padding region in the 2D image. For example, where the projection format is an ERP family, padded_region may indicate whether the region to be padded is one side region (i.e., left region or right region) or both side regions (see FIG. 4 to be described below). In addition, padded_region may indicate padding of the top and bottom regions in addition to the left and right regions. Table 6 shows example values of padded_region.

TABLE 6

| Index | Description |
|---|---|
| 0 | one (right or left) side |
| 1 | both sides |
| 2 | one side + top/bottom |
| 3 | both sides + top/bottom |

padded_type_idx is a syntax element for the information indicating a configuration type of the padding region. For example, when the projection format is a CMP family or an ECP, padding may be performed by grouping multiple faces into a group, where padded_type_idx may refer to various configurations that group the faces for padding. Table 7 shows example values of padded_type_idx.

TABLE 7

| Index | Description | |
|---|---|---|
| 0 | 1 | piece |
| 1 | 2 | pieces |
| 2 | n | pieces |

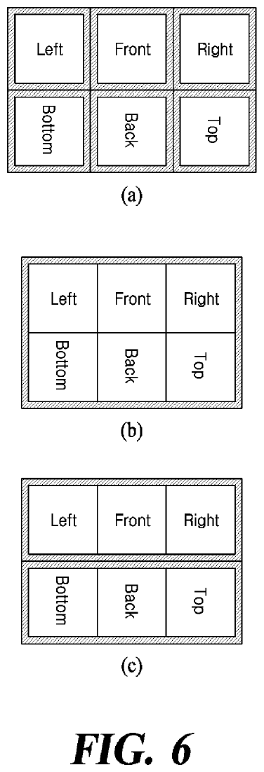

According to the example of Table 7, when the projection format is CMP and padding is performed on the out-of-face region for each of the six faces, the value of this syntax becomes “2” (see FIG. 6 at (a) to be described). As another example, when the projection format is ECP and the padding is dividedly performed on the top group and the bottom group, the value of this syntax is “1” (see FIG. 6 at (c) to be described below). The aforementioned syntax elements of the padding information of the 2D image are transferred to the decoding apparatus for the same to utilize the syntax elements for removing the padding region from the 2D reconstructed image and outputting to a renderer the 2D reconstructed image with its padding region removed. All syntax elements for the padding information of the 2D image may be included in the header of the bitstream, and the header of the bitstream may include a sequence parameter set (SPS), a picture parameter set (PPS), a video parameter set (VPS), and supplementary enhancement information (SEI). For example, the syntax for the projection format (projection_format_idx) of the 360-video may be located in the SPS. The syntax for one or more of information indicating whether or not the 2D image is padded, information indicating the width of the padding region, information indicating the location of the padding region, and information indicative of the configuration type of the padding region may be located in the PPS. Meanwhile, the names of syntax elements are merely for illustrative purpose and the present disclosure is not limited thereto.

The following will describe example methods of padding a 2D image according to the type of projection format with reference to FIGS. 4 to 11.

ERP family (ERP, EAP, AEP)

FIG. 4 shows diagrams of example padding regions for the ERP family projection format.

As shown in FIG. 4, when using projection formats belonging to the ERP family, the encoding apparatus may pad the left and right regions and/or the top and bottom regions outside the 2D image. In FIG. 4, (a) and (b) illustrate padding of the left and right regions, and (c) illustrates padding of the top and bottom regions. In the case of padding for the left and right regions, padding may be performed on both left and right sides as shown in (a) of FIG. 4, and padding may be performed exclusively on the right side (or left side). Padding of the top and bottom regions as shown in (c) of FIG. 4 may be performed along with padding of the left and right regions.

The pixel value used in padding may be an adjacent pixel value in the 2D image (original image). For example, when padding the right region outside the 2D image, an original pixel value adjacent to the left boundary in the 2D image may be used. As another example, when padding the left region outside the 2D image, an original pixel value adjacent to the right boundary in the 2D image may be used.

FIG. 5 is a diagram of example padding for the ERP family projection format. FIG. 5 illustrates example padding performed on all of the left, right, top and bottom regions outside the 2D image.

As for the padding of the top region outside the 2D image, the encoding apparatus divides the top region into left and right sides in the 2D image and uses the pixel value of the top left region for padding the top right region outside the 2D image and uses the pixel value of the top right region for padding the top left region outside of the 2D image. In the same way, the bottom region can be padded.

2) CMP Family (CMP, ACP, EAC)

FIG. 6 shows diagrams of example padding regions for the CMP family projection format.

As shown in FIG. 6, when using projection formats belonging to the CMP family, the encoding apparatus may configure various types of padding regions for six faces (Left, Front, Right, Bottom, Back, and Top). In FIG. 6, (a) illustrates case of padding the outer regions of each of the six faces, (b) illustrates case of grouping the six faces into one group and then padding the regions outside the groups, and (c) illustrates case of grouping the upper three faces and lower three faces into two upper and lower single groups and then padding the outer regions of each of the upper group and the lower group. In (c) of FIG. 6, the three faces belonging to a group are adjacent to each other in 3D space.

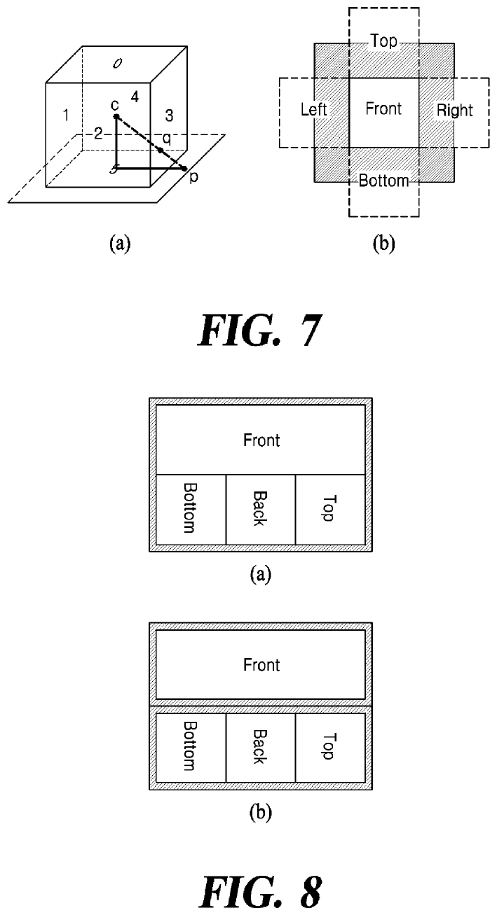

FIG. 7 show conceptual diagrams for describing a method of obtaining a pixel value used for padding.

As methods of obtaining a pixel value (that is, a padding value) used for padding, there are a geometry-based padding method and a face-based padding method. In FIG. 7, (a) is a conceptual diagram for explaining the geometry-based padding, and (b) is a conceptual diagram for explaining the face-based padding.

As shown in (a) of FIG. 7, the geometry-based padding calculates a padding value by using a center point c of a cube and information on adjacent faces in 3D space. Specifically, some embodiments obtain a straight line connecting the center point c of the cube and the pixel to be padded and utilize the pixel value on the face in contact with the straight line as the padding value. For example, a method is provided for padding a specific point p that is outside a bottom face 5 but exists on the same face, which includes finding a straight line connecting the cube center point c and point p, and using information on the right face at 3 adjacent to the bottom face 5 to obtain a value of point of contact q on right face 3, which meets the straight line for padding point p with the value of contact point q. The encoding apparatus may perform such a process on all pixel positions belonging to an outer region of bottom face 5 to perform padding on bottom face 5.

As shown in (b) of FIG. 7, the face-based padding obtains a padding value by using information on adjacent faces in 3D space. For example, a method is provided for padding outside the front face region, which utilizes the top, bottom, left, and right faces adjacent to the front face in 3D space to obtain the padding value outside the front face. This allows the pixel values of the adjacent faces to be used directly as the padding value.

3) ECP

FIG. 8 shows diagrams of example padding regions of the ECP projection format.

The ECP projection format has a compact layout composed of one large face and three small faces. The encoding apparatus may configure four faces into a single group and configure the outer region of the single group as a padding region as shown in (a) of FIG. 8. Alternatively, the encoding apparatus may group the lower faces in the layout into a lower single group and thereby configure the outer region of each of the one large face and the lower single group as a padding region as shown in (b) of FIG. 8. Here, the three faces belonging to the lower single group are adjacent to each other in 3D space. The pixel value (i.e., padding value) used in padding may be obtained by using the above-described geometry-based padding or the face-based padding.

4) SSP

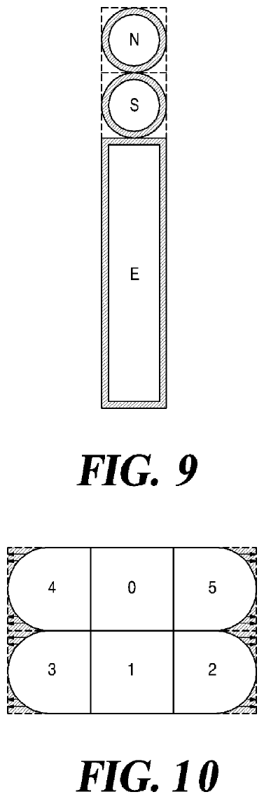

FIG. 9 is a diagram of example padding regions of the SSP projection format.

The SSP projection format has a layout composed of one rectangular face and two circular faces. The encoding apparatus may pad the outer region of the one rectangle and the outer region of each of the two circles as shown in FIG. 9. In this case, the pixel value used when padding the outer region of the rectangle may be the very pixel value inside the rectangle and adjacent to its boundary, and the pixel value used when padding the outer region of each of the two circles may be the very pixel value inside each circle and adjacent to its boundary.

5) RSP

FIG. 10 is a diagram of example padding regions of the RSP projection format.

The RSP projection format has a layout composed of two rounded rectangular faces. As shown in FIG. 10, the encoding apparatus may use a pixel value in the face and adjacent to its boundary to perform padding on outer regions of the face. For example, the encoding apparatus may perform padding on the out-of-face regions such as padding the top left region by using pixel values adjacent to the left boundary of the upper face, padding the top right region by using pixel values adjacent to the right boundary of the upper face, padding the bottom left region by using pixel values adjacent to the left boundary of the lower face, and padding the bottom right region by using pixel values adjacent to the right boundary of the lower face.

6) OHP, ISP

The OHP has a layout of eight triangular faces, the ISP has a layout of twenty triangular faces, and there are various compact layouts for each of the projection format. The encoding apparatus pads the discontinuity edge generated when arranging a plurality of faces in a 2D image according to the two projection formats.

According to at least one embodiment, the encoding apparatus may generate a space having the width of n pixels in the discontinuity edge and fill the space with interpolation values of boundary pixels in both side faces adjacent thereto. According to another embodiment, the encoding apparatus may correct values of pixels located in the discontinuity edge with interpolation values of boundary pixels in both side faces adjacent to the discontinuity edge.

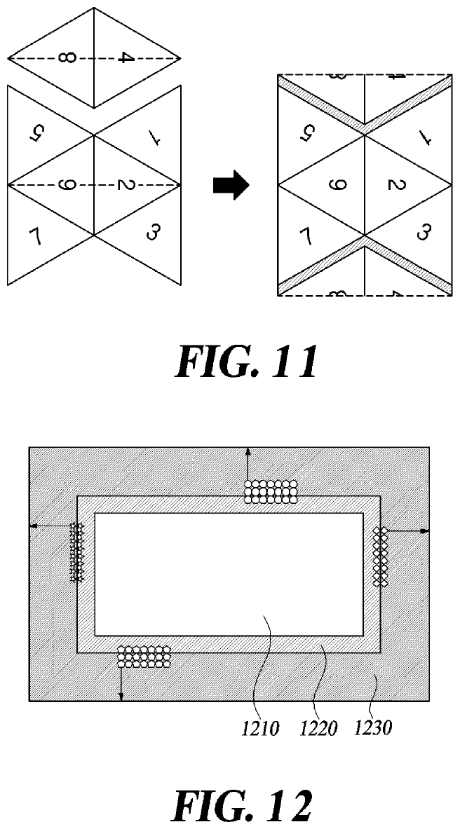

FIG. 11 is a diagram of example padding regions of the OHP projection format. FIG. ii shows an example compact layout of the OHP projection format.

As shown in FIG. ii, there is a discontinuity between faces 4 and 8 and the remaining faces (faces 1, 5, 3, and 7). The encoding apparatus may pad the discontinuity edge between faces 8 and 5 by using interpolation values of the boundary pixel values of face 8 and the boundary pixel values of face 5, and it may likewise pad discontinuity edges between the remaining faces 1 and 4, between faces 7 and 8, and between faces 3 and 4.

Although the present embodiment has been described using OHP and ISP as an example, the padding method of the present embodiment may be similarly applied to other projection formats using various polyhedrons.

The following describes, referring to FIG. 12 and FIG. 14, when using a reconstructed 2D image after encoding/decoding as a reference picture in inter prediction, how to set the type of a reference picture differently according to whether or not the 2D image is padded in order to increase compression performance. The method may be performed by both the encoding apparatus and the decoding apparatus.

The types of reference pictures according to at least one embodiment of the present disclosure are set as shown in Table 8.

TABLE 8

| Case | Padding of 2D Image | Padding of Reference Picture |
|---|---|---|
| 1 | ◯ | X |
| 2 | | ◯ (copy method) |
| 3 | X | ◯ (copy method) |
| 4 | | ◯ (extension method) |

In Table 8, copy method means padding performed by using pixel values adjacent to the boundary of the reconstructed 2D image through simply copying those values. Extension method means padding in the same manner of padding the original 2D image as described with reference to FIGS. 4 to 11. In particular, padding is performed through expanding a 2D image by using adjacency in 3D space. When the reconstructed 2D image is a padded image, there are two possible types of reference pictures. According to at least one embodiment, an encoding/decoding apparatus uses the reconstructed 2D image as a reference picture without performing padding. In other words, when the reconstructed 2D image is a padded image, the encoding/decoding apparatus stores the 2D image as a reference picture in a reference picture buffer. For example, where the projection format is CMP and each of the six faces in the 2D image are all padded (see (a) of FIG. 6), the reconstructed image is used straight as the reference picture without padding with respect to the outer region of the reconstructed image.

According to another embodiment, where the reconstructed 2D image is a padded image, the encoding/decoding apparatus additionally pads the reconstructed 2D image by a copy method and uses the padded 2D reconstructed image as a reference picture. In other words, the encoding/decoding apparatus additionally pads the 2D reconstructed image by using pixel values adjacent to the boundary of the padded 2D reconstructed image and stores the resultant padded 2D reconstructed image in the reference picture buffer as a reference picture.

FIG. 12 shows an example reference picture type according to the ERP projection format.

Where the reconstructed 2D image is an image 1220 after padding at a projection image 1210 according to the ERP projection format, the encoding/decoding apparatus may pad the outer region of the reconstructed 2D image 1220 obtained by using pixel values adjacent to the boundary of the reconstructed 2D image 1220 (that is, using values of the reconstructed boundary pixels), and may store the resultant padded 2D reconstructed image 1230 as a reference picture to be used for inter-screen prediction. FIG. 12 illustrates a reference picture padded by a copy method.

Meanwhile, where the reconstructed 2D image is an unpadded image, the reference picture may have two types. According to at least one embodiment, the encoding/decoding apparatus pads the outer region of the reconstructed 2D image by a copy method and uses the padded reconstructed 2D image as a reference picture. In other words, when the reconstructed 2D image is not padded, the encoding/decoding apparatus pads the 2D image by using pixel values adjacent to the boundary of the 2D image and stores the resultant padded 2D image as a reference picture in the reference picture buffer.

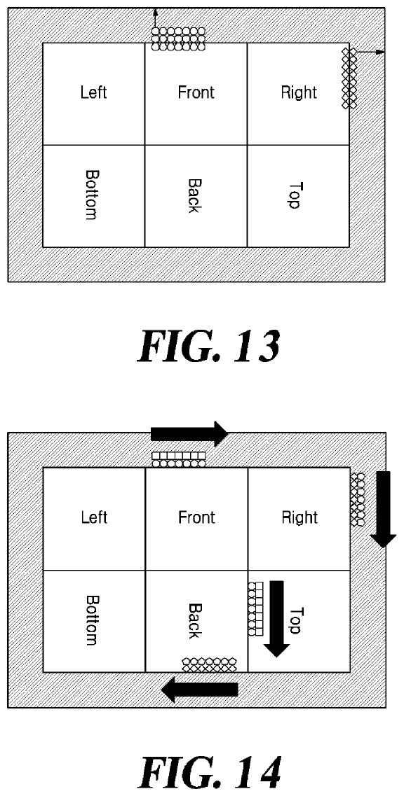

FIG. 13 is a diagram of an example reference picture type according to the CMP projection format according to at least one embodiment of the present disclosure and illustrates padding according to a copy method.

Where the reconstructed 2D image is an image not padded according to the CMP projection format, the encoding/decoding apparatus may use pixel values adjacent to the boundaries of the respective sides of the reconstructed 2D image (i.e., use the values of the reconstructed boundary pixels) for padding the outer region of the reconstructed 2D image and storing the resultant padded reconstructed 2D image as a reference picture.

According to another embodiment, where the reconstructed 2D image is an unpadded image, the encoding/decoding apparatus pads the reconstructed 2D image in a manner according to a projection format of the reconstructed 2D image. In other words, the encoding/decoding apparatus pads the 2D image according to the projection format of the reconstructed 2D image and stores the resultant padded reconstructed 2D image in the reference picture buffer as a reference picture.

FIG. 14 is a diagram of an example reference picture type according to the CMP projection format according to at least one embodiment of the present disclosure and illustrates padding according to an extension method.

Where the reconstructed 2D image is an image not padded according to the CMP projection format, the encoding/decoding apparatus may pad the outer region of the reconstructed image according to a geometry-based padding method or a face-based padding method. However, the padding value used at this time is the values of the reconstructed pixels in the reconstructed 2D image instead of the original pixel values.

The above-described information about the padding type (i.e., no padding, copying, or extending) of the reference picture need not be transmitted from the encoding apparatus to the decoding apparatus when the same apparatuses are set to take the same padding type in configuring the reference picture. However, when such setting is not made, the encoding apparatus may transmit the information about the employed padding type for the reference picture to the decoding apparatus, and the decoding apparatus may decode, from a bitstream, the received information about the employed padding type for the reference picture and pad the reference picture in a type corresponding to the decoded information. Table 9 shows an example syntax element indicating information on the padding type of the reference picture.

TABLE 9

| Index | Description |
|---|---|
| 0 | not padded |
| 1 | Padded (copy) |
| 2 | Padded (extension) |

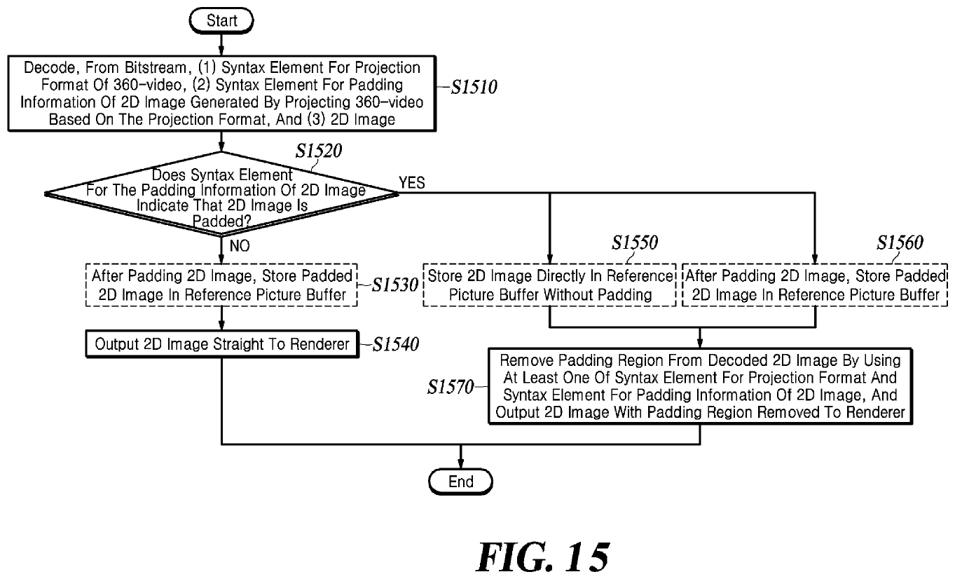

A syntax element indicating information about the padding type of a reference picture may be included in a header of a bitstream, which may include a sequence parameter set (SPS), a picture parameter set (PPS), a video parameter set (VPS), and a supplementary enhancement information (SEI). Meanwhile, the names of syntax elements are merely examples and the present disclosure is not limited thereto. FIG. 15 is a flowchart of a method of decoding a 360-video according to at least one embodiment of the present disclosure. The method of FIG. 15 may be performed by the decoding apparatus.

As shown in FIG. 15, the decoding apparatus decodes, from a bitstream, a syntax element for the projection format of the 360-video and a syntax element for padding information of a 2D image generated by projecting the 360-video 2-dimensionally based on the projection format, and it further decodes the 2D image from the bitstream (S1510). The padding information of the 2D image may include information indicating whether the 2D image is padded, and may further include at least one of information indicating the width of the padding region, information indicating the position of the padding region with respect to the 2D image, and information indicating the configuration of the padding region. Example syntax elements are as described above, which include a syntax element for the projection format of a 360-video, a syntax element for the information indicating whether the 2D image is padded, a syntax element for the information indicating the position of a padding region in the 2D image, a syntax element for the information indicating the width of the padding region, and a syntax element for the information indicating a configuration type of the padding region.

The decoding apparatus checks whether or not the syntax element for the padding information of the decoded 2D image indicates that the 2D image is padded (S1520). When the syntax element for the padding information of the 2D image does not indicate that the 2D image is padded, the decoding apparatus outputs the decoded 2D image straight to the renderer (S1540). On the contrary, when the syntax element for the padding information of the 2D image indicates that the 2D image is padded, the decoding apparatus removes the padding region from the decoded 2D image by using at least one of the syntax element for the projection format and the syntax element for the padding information of the 2D image and output the 2D image from which the padding region is removed to the renderer (S1570). In other words, the decoding apparatus specifies a padding region of the 2D image from at least one of the syntax element for the projection format and the syntax element for the padding information of the 2D image and removes the specified padding region from the decoded 2D image.

In addition, the decoding apparatus may use the decoded 2D image as a reference picture for inter prediction, wherein the type of the reference picture may be set differently according to the padding information of the 2D image (see Table 8 above). When the syntax element for the padding information of the 2D image indicates that the 2D image is not padded, the decoding apparatus may pad the 2D image and then store the padded 2D image as a reference picture in the reference picture buffer (S1530). In this case, the decoding apparatus may pad the decoded 2D image in two ways (copy method or extension method). According to the copy method, the decoding apparatus pads the decoded 2D image by using pixel values adjacent to the boundary of the decoded 2D image (see FIG. 13). According to the extension method, the decoding apparatus pads the decoded 2D image according to the projection format indicated by the syntax for the projection format of the 360-video (see FIG. 14).

On the contrary, the syntax element for the padding information of the 2D image indicates that the 2D image is padded, the decoding apparatus may store the decoded 2D image directly in the reference picture buffer as a reference picture without padding (S1550). As another example, the decoding apparatus may additionally pad the decoded 2D image by using pixel values adjacent to a boundary of the decoded 2D image (i.e., padding by copy method) and then store the additionally padded 2D image as a reference picture in the reference picture buffer (S1560).

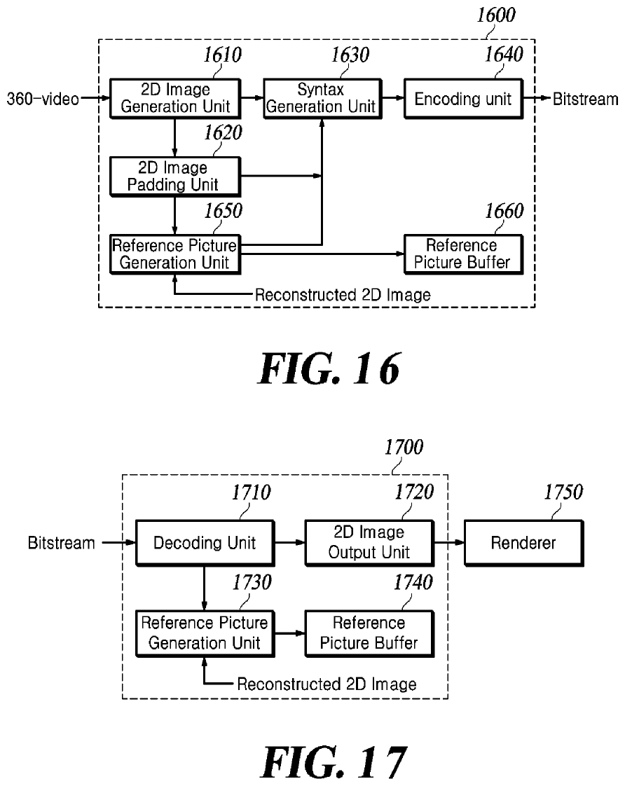

FIG. 16 is a schematic block diagram of an encoding apparatus 1600 for encoding a 360-video according to at least one embodiment of the present disclosure. The encoding apparatus 1600 may be used as the encoding apparatus of FIG. 1.

The encoding apparatus 1600 for a 360-video includes a 2D image generation unit 1610, a 2D image padding unit 1620, a syntax generation unit 1630, and an encoding unit 1640. The apparatus 1600 may further include a reference picture generation unit 1650 and a reference picture buffer 1660. The components shown in FIG. 16 may be implemented by a hardware chip, or may be implemented in software so that a microprocessor executes functions of software corresponding to the respective components.

The 2D image generation unit 1610 generates a 2D image by projecting a 360-video based on any one of the one or more projection formats. Example projection formats may include ERP, EAP, AEP, CMP, ACP, EAC, ECP, SSP, RSP, ISP, OHP, and the like. Here, the projection format for projecting the 360-video may be selected from a plurality of projection formats by the encoding apparatus, or may be preset to a specific projection format.

The 2D image padding unit 1620 pads an outer region or a discontinuity edge of the 2D image on which the 360-video has been projected. The 2D image padding unit 1620 pads the 2D image in different ways according to the type of projection format applied. Description of various padding schemes has been described above with reference to FIGS. 4 to 11, and thus a detailed description thereof will be omitted.

In order to use the encoded and then reconstructed 2D image as the reference picture in inter-prediction, the reference picture generation unit 1650 adaptively sets the type of the reference picture according to whether or not the 2D image is padded and stores the setting in the reference picture buffer 1660. In FIG. 16, the configuration for reconstructing the 2D image is omitted.

The reference picture types are as described above with reference to Table 8. In particular, when the 2D image is padded, the reference picture generation unit 1650 may set the 2D image straight as a reference picture without padding the 2D image or may use pixel values adjacent to the boundary of the padded 2D image (copy method) for setting the result of additional padding of the 2D image (see FIG. 12) as a reference picture. Meanwhile, when the 2D image is not padded, the reference picture generation unit 1650 may use pixel values adjacent to the boundary of the 2D image (copy method) for setting the result of padding of the 2D image (see FIG. 13) as a reference picture or may take a method corresponding to the type of projection format applied (extension method) in padding the 2D image (see FIG. 14) for setting the result of such 2D image padding as a reference picture.

The syntax generation unit 1630 generates a syntax element for the underlying projection format for generating the 2D image and generates a syntax element for the padding information of the 2D image. Here, the padding information of the 2D image may include information indicating whether the 2D image is padded, and may further include at least one of information indicating the width of the padding region, information indicating the position of the padding region with respect to the 2D image, and information on a configuration type of the padding region. Examples of the syntax element for the projection format and the syntax element for the padding information of the 2D image are the same as described above with reference to Tables 1 to 11.

In addition, the syntax generation unit 1630 may generate a syntax element for the reference picture type set by the reference picture generation unit 1650 (i.e., for the padding information of the 2D image stored as the reference picture). However, the information on the padding type (e.g., no padding, copy, extension) of the reference picture needs no syntax element to be generated by the syntax generation unit 1630 when the encoding apparatus and the decoding apparatus are set to take the same padding type in configuring the reference picture.

The encoding unit 1640 encodes the generated syntax elements and encodes a padded or unpadded 2D image.

FIG. 17 is a schematic block diagram of a decoding apparatus 1700 for decoding a 360-video according to at least one embodiment of the present disclosure. The decoding apparatus 1700 may be used as the decoding apparatus of FIG. 2.

The decoding apparatus 1700 for a 360-video includes a decoding unit 1710 and a 2D image output unit 1720. The decoding apparatus 1700 may further include a reference picture generation unit 1730 and a reference picture buffer 1740. The components shown in FIG. 17 may be implemented by a hardware chip, or may be implemented in software so that a microprocessor executes functions of software corresponding to the respective components.

The decoding unit 1710 decodes, from the bitstream, the syntax element for the projection format of the 360-video and the syntax element for the padding information of the 2D image on which the 360-video has been projected based on that projection format. In addition, the decoding unit 1710 decodes the 2D image from the bitstream. The detailed description of the syntax element for the projection format and the syntax element for the padding information of the 2D image is the same as described above.

The 2D image output unit 1720 is responsive to when the syntax element for the padding information of the 2D image indicates that the 2D image is padded for utilizing the syntax element for the projection format and the syntax element for the padding information of the 2D image to remove the padding region from the decoded 2D image and thereafter output the 2D image with the padding region removed to the renderer 1750. In other words, the 2D image output unit 1720 specifies a padding region of the 2D image from at least one of the syntax element for the projection format and the syntax element for the padding information of the 2D image and removes the specified padding region from the decoded 2D image and then outputs the latter save the padding region to the renderer 1750. The 2D image output unit 1720 outputs the decoded 2D image straight to the renderer 1750 when the syntax element for the padding information of the 2D image indicates that the 2D image is not padded.

The reference picture generation unit 1730 does or does not pad the decoded 2D image (i.e., reconstructed 2D image) according to the syntax element for the padding information of the 2D image, which indicates whether or not the 2D image is padded. In particular, when the 2D image is padded, the reference picture generation unit 1730 may set the 2D image directly as a reference picture without padding the 2D image or utilize pixel values adjacent to the boundary of the padded 2D image (utilize copy method) for setting the result of additionally padding the 2D image (see FIG. 12) as the reference picture. On the other hand, when the 2D image is not padded, the reference picture generation unit 1730 may utilize pixel values adjacent to the boundary of the 2D image (utilizes copy method) for setting the result of padding the 2D image (see FIG. 13) as a reference picture or take a method corresponding to the type of projection format applied (extension method) in padding the 2D image (see FIG. 14) for setting the result of such 2D image padding as a reference picture.

The reference picture generation unit 1730 stores the padded or unpadded 2D image in the reference picture buffer 1740 as a reference picture to be used for inter-screen prediction as indicated whether or not the 2D image is padded.

Although FIG. 3 and FIG. 15 describe the respective steps as being sequentially performed, they are not necessarily limited to the instantiated sequences. In other words, a person having ordinary skill in the pertinent art could appreciate that various modifications, additions, and substitutions are possible by changing the sequences described in FIG. 3 and FIG. 15 or by performing two or more of the steps in parallel, without departing from the gist and the nature of the embodiments of the present disclosure, and hence the steps in FIG. 3 and FIG. 15 are not limited to the illustrated chronological sequences.

The 360-video encoding or decoding method according to some embodiments of the present disclosure illustrated in FIG. 3 and FIG. 15 may be implemented in a computer program and recorded on a computer-readable recording medium. A non-transitory computer-readable recording medium may be provided for recording the computer program for implementing the 360-video encoding or decoding method according to some embodiments and include any type of recording device on which data that can be read by a computer system are recordable.

Although exemplary embodiments of the present disclosure have been described for illustrative purposes, those skilled in the art will appreciate that various modifications, additions and substitutions are possible, without departing from the idea and scope of the claimed invention. Therefore, exemplary embodiments of the present disclosure have been described for the sake of brevity and clarity. The scope of the technical idea of the present embodiments is not limited by the illustrations. Accordingly, one of ordinary skill would understand the scope of the claimed invention is not to be limited by the above explicitly described embodiments but by the claims and equivalents thereof.

### CROSS-REFERENCE TO RELATED APPLICATION

This application claims priority from Korean Patent Application No. 10-2017-0097273 filed on Jul. 31, 2017, and Korean Patent Application No. 10-2017-0113525 filed on Sep. 5, 2017, the disclosures of which are incorporated by reference herein in their entireties.

1. A method of encoding a 360-degree video, comprising:
generating a 2-dimensional (2D) image by projecting the 360- degree video based on one of the one or more projection formats;
encoding the 2D image that is padded or unpadded according to whether or not the 2D image is padded according to any one underlying projection format out of the projection formats; and
encoding a syntax element for padding information of the 2D image.

2. The method of claim 1, wherein the padding information of the 2D image comprises:
information indicating whether or not the 2D image is padded.

3. The method of claim 2, wherein the padding information of the 2D image further comprises:
information indicating a width of a padding region.

4. The method of claim 2, wherein the padding information of the 2D image further comprises:
at least one of information indicating a position of a padding region with respect to the 2D image and information indicating a configuration type of the padding region.

5. The method of claim 1, further comprising:
when the 2D image is padded, storing the 2D image that is padded in a reference picture buffer as a reference picture to be used for an inter-screen prediction.

6. The method of claim 1, further comprising:
when the 2D image is padded, additionally padding the 2D image that is padded by using pixel values adjacent to a boundary of the 2D image that is padded; and
storing the 2D image that is additionally padded in a reference picture buffer as a reference picture to be used for an inter-screen prediction.

7. The method of claim 1, further comprising:
when the 2D image is not padded, padding the 2D image by using pixel values adjacent to a boundary of the 2D image; and
storing the 2D image that is padded in a reference picture buffer as a reference picture to be used for an inter-screen prediction.

8. The method of claim 1, further comprising:
when the 2D image is not padded, padding the 2D image according to the any one underlying projection format; and
storing the 2D image that is padded in a reference picture buffer as a reference picture to be used for an inter-screen prediction.

9. The method of any one of claims 5 to 8 claim 5, further comprising:
encoding a syntax element for padding information of the 2D image stored as the reference picture.

10. A method of decoding a 360-degree video, comprising:
decoding, from a bitstream, a syntax element for a projection format of the 360-degree video and a syntax element for padding information of a 2-dimensional (2D) image generated by projecting the 360-degree video based on the projection format, and decoding the 2D image from the bitstream;
when the syntax element for the padding information of the 2D image indicates that the 2D image is padded, removing a padding region from a decoded 2D image by using at least one of the syntax element for the projection format and the syntax element for the padding information of the 2D image, and then outputting the 2D image with the padding region removed to a renderer; and
when the syntax element for the padding information of the 2D image indicates that the 2D image is not padded, outputting the decoded 2D image straight to the renderer.

11. The method of claim 10, wherein the padding information of the 2D image comprises:
information indicating whether or not the 2D image is padded.

12. The method of claim 11, wherein the padding information of the 2D image further comprises:
information indicating a width of the padding region.

13. The method of claim 11, wherein the padding information of the 2D image further comprises:
at least one of a position of the padding region with respect to the 2D image and a configuration type of the padding region.

14. The method of claim 10, further comprising:
when the syntax element for the padding information of the 2D image indicates that the 2D image is padded, storing the decoded 2D image in a reference picture buffer as a reference picture to be used for an inter-screen prediction.

15. The method of claim 10, further comprising:
when the syntax element for the padding information of the 2D image indicates that the 2D image is padded, additionally padding the 2D image by using pixel values adjacent to a boundary of the decoded 2D image; and
storing the 2D image that is additionally padded in a reference picture buffer as a reference picture to be used for an inter-screen prediction.

16. The method of claim 10, further comprising:
when the syntax element for the padding information of the 2D image indicates that the 2D image is not padded, padding the 2D image by using pixel values adjacent to a boundary of the decoded 2D image; and
storing the 2D image that is padded in a reference picture buffer as a reference picture to be used for an inter-screen prediction.

17. The method of claim 10, further comprising:
when the syntax element for the padding information of the 2D image indicates that the 2D image is not padded, padding the decoded 2D image according to a projection format indicated by the syntax element for the projection format of the 360-degree video; and
storing the 2D image that is padded in a reference picture buffer as a reference picture to be used for an inter-screen prediction.

18. The method of claim 10, further comprising:
decoding a syntax element for padding information of a reference picture from the bitstream;
padding or not padding the decoded 2D image as indicated by the syntax element for the padding information of the reference picture; and
storing the 2D image that is padded or unpadded in a reference picture buffer as a reference picture to be used for an inter-screen prediction.

19. An apparatus for decoding a 360-degree video, comprising:
a decoding unit configured to decode, from a bitstream, a syntax element for a projection format of the 360-degree video and a syntax element for padding information of a 2-dimensional (2D) image generated by projecting the 360- degree video based on the projection format, and to decode the 2D image from the bitstream; and
a 2D image output unit configured to remove a padding region from a decoded 2D image by using at least one of the syntax element for the projection format and the syntax element for the padding information of the 2D image when the syntax element for the padding information of the 2D image indicates that the 2D image is padded, and then to output the 2D image with the padding region removed to a renderer, but to output the decoded 2D image to the renderer when the syntax element for the padding information of the 2D image indicates that the 2D image is not padded.

20. The apparatus of claim 19, further comprising:
a reference picture generation unit configured
to pad or not to pad the decoded 2D image as indicated by the syntax element for the padding information of the 2D image as to whether or not the 2D image is padded, and
to store the 2D image that is padded or unpadded in a reference picture buffer as a reference picture to be used for an inter-screen prediction.
